(19) United States
(12) Patent Application Publication
(10) Pub. No.: US 2007/0224485 A1
(43) Pub. Date: Sep. 27, 2007

(54) Fuel cell system and its control method

(76) Inventors: Jun Young Park, Seoul (KR); Jin Hwa Lee, Yongin-si (KR); In Seob Song, Yongin-si (KR); Ji Rae Kim, Yongin-si (KR)

Correspondence Address: Robert E. Bushnell, Suite 300, 1522 K Street, N.W., Washington, DC, 20005-1202, US

(21) Appl. No.: 11/652,017

(22) Filed: Jan. 11, 2007

(30) Foreign Application Priority Data
Mar. 22, 2006 (KR) 10-2006-0026191

(51) Int. Cl. H01M 8/04; H01M 8/10

(52) U.S. Cl. 429/34; 429/30; 429/23; 429/13

(57) ABSTRACT

A fuel cell system having an activating apparatus and its driving method has an electric generator including a membrane having opposite sides respectively provided with anode and cathode electrodes in which an oxidation-reduction reaction of hydrogen and oxygen is performed; and a purging gas supplying unit to supply purging gas to the cathode electrodes, so that a flow path for an oxidant in the cathode electrodes is recovered to thereby enhance the power generating efficiency of the electric generator.

### CLAIM OF PRIORITY

This application makes reference to, incorporates the same herein, and claims all benefits accruing under 35 U.S.C. §119 from an application for FUEL CELL SYSTEM HAVING ACTIVATING APPARATUS AND METHOD FOR DRIVING THE SAME earlier filed in the Korean Intellectual Property Office on the Mar. 22, 2006 and there duly assigned Serial No. 2006-0026191.

### BACKGROUND OF THE INVENTION

1. Field of the Invention

The present invention relates to a fuel cell system and its control method. More particularly, the present invention relates to a fuel cell system and its control method, in which purging gas is supplied from a purging gas supplying unit to a cathode electrode such that water and/or impurities remaining in the cathode electrode are forcibly discharged, thereby recovering an oxidant flow path and enhancing the power generation efficiency.

2. Description of the Related Art

A fuel cell system has attracted attention as an alternative to solve the problems of the environment or resources. In general, the fuel cell system generates electricity through an electrochemical reaction between an oxidant, such as oxygen in air, and hydrogen obtained from a hydrocarbonaceous fuel, such as natural gas, etc. or from a hydrogen containing fuel, such as methanol, etc.

Such a fuel cell system includes an electric generator to generate the electricity. The electric generator includes unit cells, and each unit cell includes a membrane electrode assembly (MEA). Furthermore, the membrane electrode assembly includes an electrolyte membrane having an ion selective transport property, and anode and cathode electrodes respectively provided on opposite sides of the electrolyte membrane. When the fuel cell system operates for a long time, water and/or impurities are likely to be accumulated in the membrane electrode assembly (in particular, in the cathode electrode), so that the flow of the oxidant is deteriorated, thereby lowering the power generation efficiency in the fuel cell system.

Fuel cell systems are classified into active fuel cell systems and passive fuel cell systems according to the arrangement of the unit cells, for example, how the unit cells are stacked and how they are arranged on a plane. In the passive fuel cell system, the cathode electrode is exposed to air.

When the passive fuel cell system operates, there is no pressure drop in the cathode electrode exposed to air, so that a cathode-flooding phenomenon problem arises and causes the efficiency of power generation to be lowered.

In more detail, the electrochemical reaction between hydrogen and oxygen allows the cathode electrode to produce water, but the water may not be discharged from the cathode electrode, thereby lowering the power generation efficiency.

A fuel cell system discussed in Japanese First Publication No. 2005-116360 (see FIG. 3 of the accompanying drawings) includes a vibrator to vibrate a fuel cell main body so as to remove air bubbles remaining in an anode electrode because air bubbles, such as carbon dioxide, produced and remaining in the anode electrode deteriorate the performance of the fuel cell system.

However, such a fuel cell system has no structure to effectively solve the cathode-flooding phenomenon problem due to water and/or impurities accumulating in the cathode electrode.

### SUMMARY OF THE INVENTION

Accordingly, it is an object of the present invention to provide a fuel cell system and its control method, in which the system removes water and/or impurities which are not smoothly discharged and are accumulated in a cathode electrode when an electric generator of the fuel cell system operates for a long time.

Another object of the present invention is to provide a fuel cell system and its control method, in which purging gas is supplied to a cathode electrode removes water and impurities accumulated in the cathode electrode, thereby recovering an oxidant flow path and enhancing the power generation efficiency.

The foregoing and/or other objects of the present invention are achieved by providing a fuel cell system including: an electric generator including a membrane having opposite sides respectively including anode and cathode electrodes in which an oxidation-reduction reaction of hydrogen and oxygen is performed; and a purging gas supplying unit adapted to supply purging gas to the cathode electrodes.

The purging gas supplying unit preferably includes a gas storage tank adapted to store an inert gas. The inert gas preferably includes a gas selected from a group consisting of: argon, nitrogen, hydrogen, and a mixture thereof.

The fuel cell system preferably further includes an air pump arranged between the gas storage tank and the cathode electrodes.

The fuel cell system preferably further includes a detector adapted to sense an output voltage level of the electric generator.

The fuel cell system preferably further includes a controller having a reference voltage level to control the purging gas supplying unit according to the output voltage level of the electric generator sensed by the detector.

The controller is preferably adapted to stop the electric generator and to cause the purging gas supplying unit to supply purging gas to the cathode electrodes in response to the output voltage level of the electric generator sensed by the detector lowering to less than the reference voltage level.

The foregoing and/or other objects of the present invention are also achieved by providing a method of controlling a fuel cell system, the method including: controlling an electric generator including a membrane having anode and cathode electrodes respectively arranged at opposite sides thereof, to perform a power generating operation; sensing an output voltage level from the electric generator; stopping the power generating operation in response to the sensed output voltage level from the electric generator being less than a predetermined voltage level; supplying purging gas to the cathode electrodes; and restarting the electric generator to again perform a power generating operation after the supplying the purging gas.

The purging gas is preferably supplied from a gas storage tank storing an inert gas selected from a group consisting of: argon, nitrogen, hydrogen, and a mixture thereof to the cathode electrodes. The purging gas is preferably supplied to the cathode electrodes by an air pump arranged between the gas storage tank and the cathode electrodes.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic view of a passive fuel cell system having an activating apparatus according to an embodiment of the present invention;

FIG. 2 is a flowchart of an activating process in the fuel cell system according to an embodiment of the present invention; and

FIG. 3 is a sectional view of a Membrane Electrode Assembly (MEA) activated in a conventional Proton Exchange Membrane Fuel Cell (PEMFC).

### DETAILED DESCRIPTION OF THE DRAWINGS

Hereinafter, an exemplary embodiment of the present invention is described with reference to accompanying drawings, wherein like numerals refer to like elements throughout. In drawings, the shape and the size of elements may be exaggerated for convenience.

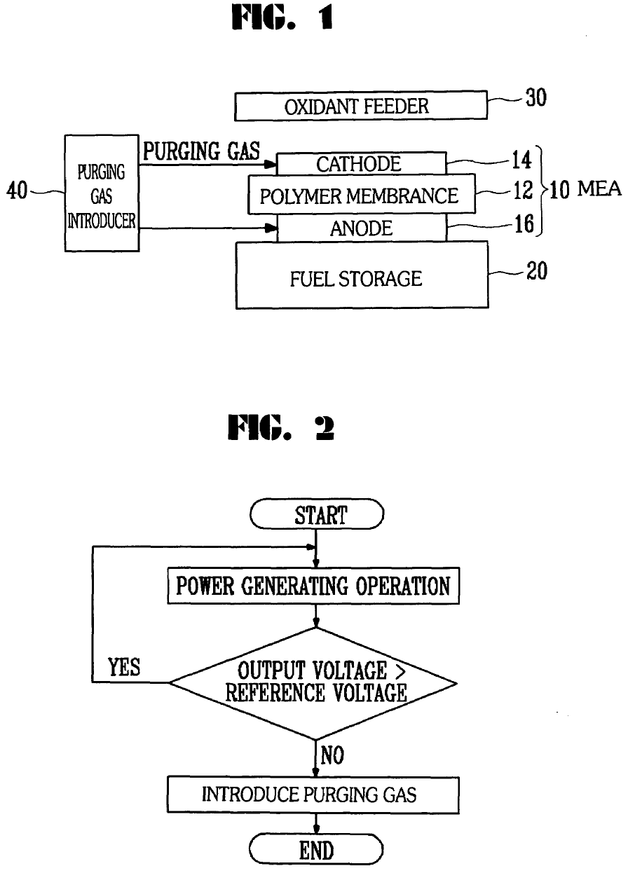

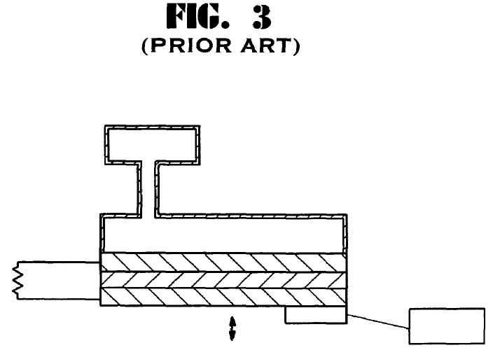

FIG. 1 is a schematic view of a passive fuel cell system having an activating apparatus according to an embodiment of the present invention, and FIG. 2 is a flowchart of an activating process in the fuel cell system according to an embodiment of the present invention.

Hereinafter, the present invention is described with reference to a passive fuel cell system by way of example. However, the present invention is not limited thereto.

As shown in FIG. 1, the passive fuel cell system includes an electric generator to generate electricity through an electrochemical reaction between hydrogen and oxygen. The electric generator includes unit cells, and each unit cell includes a Membrane Electrode Assembly (MEA) 10. Furthermore, the membrane electrode assembly 10 includes a polymer membrane 12 having an ion selective transport property, and anode and cathode electrodes 16 and 14 provided on opposite sides of the polymer membrane 12. The cathode electrode 14 is exposed to air.

Furthermore, the fuel cell system includes a housing (not shown) having an accommodating space to accommodate the electric generator. In the housing, a fuel storage 20 for storing hydrogen containing fuel is provided on one side of the electric generator, i.e., on the bottom of the anode electrode 16, and an oxidant feeder 30 for supplying an oxidant is provided on the other side of the electric generator, i.e., on top of the cathode electrode 14.

The oxidant includes pure oxygen stored in a separate storage or oxygen containing air, and the oxidant feeder 30 can include a blower or the like. Furthermore, the hydrogen containing fuel includes: an alcoholic fuel, such as methanol, ethanol, etc.; a hydrocarbonaceous fuel, such as methane, butane, etc.; or a natural gas, such as liquefied natural gas, etc. However, the present invention is not limited thereto. Preferably, the fuel storage 20 of the housing can store a mixed solution of water and at least one fuel selected from the foregoing hydrogen containing fuels supplied from a fuel feeder (not shown). For example, the mixed fuel can include a low concentration methanol solution obtained by mixing water and methanol.

When such a passive electric generator with this configuration is normally driven, the electrochemical reaction between the anode electrode 16 and the cathode electrode 14 of the electric generator is as follows.

Anode: CH₃OH+H₂O→CO₂+6H⁺+6e⁻

Cathode: ( 3/2)O₂+6H⁺+6e⁻→3H₂O

Total: CH₃OH+( 3/2)O₂→2H₂O+CO₂

In the anode electrode 16, the reaction between methanol and water produces carbon dioxide, six hydrogen ions and electrons (Oxidation reaction). Then, the produced hydrogen ions are transferred to the cathode electrode 14 through the membrane 12, for example, a hydrogen ion exchange membrane. In the cathode electrode 14, the hydrogen ions, electrons through an external circuit from the anode electrode 16 and oxygen are reacted, thereby producing water (Reduction reaction). Totally, the reaction between methanol and oxygen produces water and carbon dioxide, generating electricity. The generated electricity is then supplied to the electrical load via a collector (not shown).

While the electric generator of the passive fuel cell system normally performs a power generating operation, if water produced in the cathode electrode 14 is not smoothly discharged and remains in the cathode electrode 14, a flow path for the oxidant is obstructed by the remaining water. As the oxidant is not smoothly supplied to the cathode electrode 14, the power generating efficiency of the electric generator becomes lower. For instance, an output voltage level of the collector is lowered to less than a reference or predetermined voltage level.

Therefore, when the output voltage level from the collector is lowered to less than the reference level, the electric generator should be stopped and the water remaining in the cathode electrode 14 should be forcibly discharged.

According to the present invention, during an activation process, water remaining in the cathode electrode 14 is forcibly discharged and the flow path for the oxidant is recovered. In order to fulfill the activation process, the fuel cell system includes a purging gas introducer 40 to introduce purging gas to the cathode electrode 14. Thus, when the purging gas introducer 40 introduces the purging gas into the cathode electrode 14, water remaining in the cathode electrode 14 is forcibly discharged, resulting in the flow path for the oxidant in the cathode electrode 14 being recovered.

The purging gas includes an inert gas, such as argon or nitrogen gas, hydrogen gas, or mixed gases thereof. The kind of purging gas is determined to prevent the electrochemical reaction between the purging gas and the hydrogen containing fuel remaining in the anode electrode 16 during the activating process of the fuel cell system.

According to the present invention, the fuel cell system includes a purging gas supplying path to supply the purging gas from the purging gas introducer 40 to the cathode and anode electrodes 14 and 16.

Thus, the purging gas is supplied from the purging gas introducer 40 to the cathode and anode electrodes 14 and 16, and then water, impurities and the like remaining in the cathode and anode electrodes 14 and 16 of the membrane electrode assembly 10 are forcibly discharged, thereby recovering the flow paths of the oxidant and the hydrogen containing fuel in the cathode and anode electrodes 14 and 16.

After the activating process is applied to the electrodes 14 and 16 of the membrane electrode assembly 10 by the purging gas supplied thereto, the hydrogen containing fuel and the oxidant are supplied to thereby restart the power generating operation of the electric generator. The hydrogen containing fuel and the oxidant are smoothly supplied through the recovered flow paths, so that the power generation efficiency of the passive fuel cell system is enhanced.

While the electric generator performs the power generating operation, the output voltage from the electric generator is sensed by a voltage detector. When the output voltage level sensed by the detector is lowered to less than a reference voltage level, the electric generator is stopped and the above-described activating process is repeated.

According to the present invention, while the electric generator of the fuel cell system performs the power generating operation, water and/or impurities not discharged from and remaining in the cathode electrode are forcibly discharged by introducing the purging gas into the cathode electrode, so that the flow path for the oxidant in the cathode electrode is recovered, thereby enhancing the power generating efficiency of the electric generator.

Although an exemplary embodiment of the present invention has been shown and described, it would be appreciated by those skilled in the art that modifications can be made to this embodiment without departing from the principles and spirit of the present invention whose scope is defined by the following claims.

What is claimed is:

1. A fuel cell system, comprising:
an electric generator including a membrane having opposite sides respectively including anode and cathode electrodes in which an oxidation-reduction reaction of hydrogen and oxygen is performed; and
a purging gas supplying unit adapted to supply purging gas to the cathode electrodes.

2. The fuel cell system according to claim 1, wherein the purging gas supplying unit comprises a gas storage tank adapted to store an inert gas.

3. The fuel cell system according to claim 2, wherein the inert gas comprises a gas selected from a group consisting of: an inert gas, argon, nitrogen, hydrogen, and a mixture thereof.

4. The fuel cell system according to claim 2, further comprising an air pump arranged between the gas storage tank and the cathode electrodes.

5. The fuel cell system according to claim 3, further comprising an air pump arranged between the gas storage tank and the cathode electrodes.

6. The fuel cell system according to claim 1, further comprising a detector adapted to sense an output voltage level of the electric generator.

7. The fuel cell system according to claim 6, further comprising a controller having a reference voltage level to control the purging gas supplying unit according to the output voltage level of the electric generator sensed by the detector.

8. The fuel cell system according to claim 7, wherein the controller is adapted to stop the electric generator and to cause the purging gas supplying unit to supply purging gas to the cathode electrodes in response to the output voltage level of the electric generator sensed by the detector lowering to less than the reference voltage level.

9. A method of controlling a fuel cell system, the method comprising:
controlling an electric generator including a membrane having anode and cathode electrodes respectively arranged at opposite sides thereof, to perform a power generating operation;
sensing an output voltage level from the electric generator;
stopping the power generating operation in response to the sensed output voltage level from the electric generator being less than a predetermined voltage level;
supplying purging gas to the cathode electrodes; and
restarting the electric generator to again perform a power generating operation after the supplying the purging gas.

10. The method according to claim 9, wherein the purging gas is supplied from a gas storage tank storing a gas selected from a group consisting of: an inert gas, argon, nitrogen, hydrogen, and a mixture thereof to the cathode electrodes.

11. The method according to claim 10, wherein the purging gas is supplied to the cathode electrodes by an air pump arranged between the gas storage tank and the cathode electrodes.
